(19) United States
(12) Patent Application Publication
(10) Pub. No.: US 2024/0300401 A1
(43) Pub. Date: Sep. 12, 2024

(54) SIDE RAIL BRACKET FOR LOAD PLATFORM

(71) Applicant: Bobby M. ANDERSON, JR., Dahlonega, GA (US)

(72) Inventor: Bobby M. ANDERSON, JR., Dahlonega, GA (US)

(21) Appl. No.: 18/597,464

(22) Filed: Mar. 6, 2024

Related U.S. Application Data
(60) Provisional application No. 63/488,803, filed on Mar. 7, 2023.

(51) Int. Cl. B60P 7/08

(52) U.S. Cl. CPC B60P 7/0823; B60P 7/0815

(57) ABSTRACT

A bracket for use as an intermediate connector element for connecting a tie-down strap to a side rail of a load platform in a manner to avoid interference between the tie-down strap and a barrier element of a gate unit positioned at the perimeter of the load platform, the bracket having a body of monolithic, single piece construction with a first end and a second end, the first-end being adapted for connecting to a side rail of a load platform and the second end being adapted for connecting to a tie-down strap, wherein the bracket body is shaped and dimensioned to closely conform to outer surfaces of the load platform.

### FIELD OF THE INVENTION

The present invention relates to an apparatus and method for securing loads on a transporting load platform, such as that of a flatbed truck or trailer. In particular, the present invention is directed to a bracket that is operable as an intermediate connector element for connecting a tie-down strap to a side rail of a load platform.

### BACKGROUND OF THE INVENTION

Conventionally, flatbed trucks and trailers have load platforms positioned rear of a passenger cabin for the carrying and transporting a load. FIG. 1 shows an example of a flatbed truck 1 having a passenger cabin 2 and a load platform 3 with several gate units 7 mounted on the load platform 3. FIG. 2 shows a schematic of the load platform 3, and FIG. 3 shows a gate unit 7 in isolation. The load platform 3 has a forward cabin end 4 proximate the passenger cabin 2, a rear bumper 5 at an end opposite of the cabin end 4, and two parallel side rails 6 (a.k.a., rub rails) extending along lateral sides of the load platform 3, between the cabin end 4 and the rear bumper 5. A number of gate units 7 are provided and together form a retaining wall 8 around a perimeter of the load platform 3, at least along both side rails 6 and the rear bumper 5. Gate units 7 may also be provided to extend the retaining wall 8 along the cabin end 4 of the load platform 3.

As seen in FIG. 3, individual gate units 7 that form the retaining wall 8 include a number of slats 9 mounted horizontally on a pair of vertical stake posts 10. Commonly, the gate units 7 are made to be selectively insertable and removable from the load platform 3. This is made possible by inclusion of a number of stake pockets 11 that are positioned along the perimeter of the load platform 3 and which are configured for mating reception of lower exposed base ends 10a of the stake posts 10. The stake pockets 11 are dimensioned for reception of the base ends 10a of the stake posts 10 via vertical insertion, and adjacent gate units 10 may optionally be secured to one another via one or more securing mechanisms to form a retaining wall 8 around the load platform 3 for use in retaining a load on the load platform 3 during for transportation.

Gate units 7 may be made with a number of different dimensions and configurations apart from that shown in the illustrated example of FIG. 3. In some examples separate gate units 7 may be dimensioned to individually extend along entire sides of a load platform 3 (e.g., a single gate unit along a lateral side, a cabin side, or rear bumper side), and in some examples gate units 7 may be configured for selective displacement without requiring removal from a load platform 3. See for example U.S. Ser. No. 17/828,466 (Anderson), disclosing gate units that are selectively displaceable between a barrier forming position and an access position for enabling selective access to a load platform without requiring removal of the gate unit from the load platform. The contents of U.S. Ser. No. 17/828,466 (Anderson) are incorporated herein by reference, in their entirety.

Gate units 7 may be made with considerable variation in the barrier elements that extend between the vertical stake posts 10. FIG. 3 shows a gate unit 7 provided with a plurality of barrier elements in the form of slats 9. Examples of barrier elements that may be used in a gate unit include, though are not limited to: a plurality of slats; an individual plate or sheet of solid or perforated material; chain link fencing; mesh screening; etc. Attachment of the barrier elements along the vertical height of the stake posts 10 may also vary form one gate unit 7 to another, with some gate units providing relatively greater spacing between adjacent barrier elements and some gate units providing relatively lesser and potentially minimal spacing between adjacent barrier elements.

Conventional gate units 7 present drawbacks due to the variable constructions of the barrier elements from one gate unit to another. In particular, when placing a load onto a load platform 3, it is common practice to use one or more tic-down straps (e.g., a ratchet strap) to further secure the load in place during transport. A typical tie-down strap includes a first fastener element adapted for connecting to a first anchoring point on a load platform 3; a strap element adapted to extend toward and press against the load; and a second fastener element adapted for connecting to at least one of: a second anchoring point on the load platform 3, the load itself, and a mating attachment at the first fastener element. Some tie-down straps may include additional elements and/or mechanisms, such as a ratchet strap, which further includes a ratchet mechanism for tightening the strap element against the load. When using a tic-down strap on a load platform 3 such as that in FIGS. 1-2, it is common practice to secure at least one of the fastener elements to a side rail 6 with the strap element extending from at least one side rail 6 so as to pass under the lowest slat 9 of a gate unit 7. A problem arises however when the slats 9 (or other barrier elements) of a gate unit 7 are constructed with a relatively small clearance space between the lowest slat 9 and the load platform 3, resulting in the lowest slat 9 obstructing passage of the strap element in extending from the side rail 6 to the load platform 3. In such instances, a user may be forced to secure the tie-down strap to a less desirable anchoring point (other than the side rail 6) or otherwise forego use of the tic-down strap.

Thus, there remains a need for a means of adapting tie-down straps for use with gate units of varying dimensions and constructions.

### SUMMARY OF THE INVENTION

A bracket for use in securing a load on a load platform comprises a bracket body of monolithic, single piece construction having a first end and a second end, the first-end of the bracket body being adapted for connecting to a side rail of a load platform, and the second end being adapted for connecting to a tie-down strap, wherein the bracket body is shaped and dimensioned to closely conform to outer surfaces of the load platform.

The side rail end of the bracket body comprises a section oriented vertically for extending downward along an outer side surface of a load platform, a section oriented horizontally for extending away from the outer side surface of the load platform, and a section oriented vertically for extending upward along an outer surface of a side rail. The tie-down end of the bracket body comprises a section oriented horizontally for extending along an upper surface of the load platform, and a section oriented at an obtuse angle α relative to the horizontally oriented section for extending away from the upper surface of the load platform. The obtuse angle α is a range of 90°<α<180°, and may be within the respective ranges of: of 90°<α≤120° F. or securing large loads, 120°<α≤150° F. or securing medium sized loads, and 150°≤α<180° F. or securing small loads.

In use the bracket is positioned on a load platform with the first end of the bracket body resting against a side rail of the load platform and the second end of the bracket body resting on a load bearing region of the load platform with a section of the second end projecting upward and away from the load platform. A tie-down strap is attached to the second end of the bracket body, and a load is secured in place on the load platform with the tie-down strap. One or more gate units may then be positioned along the perimeter of the load platform, with one or more brackets positioned to extend below a lowest barrier element of one or more gate units.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a vehicle with a flatbed load platform and a number of gate units forming a retaining wall around the load platform;

FIG. 2 presents a schematic illustration of the load platform in FIG. 1;

FIG. 3 shows an isolated gate unit from FIG. 1;

FIG. 4 shows first perspective view of an example of a side rail bracket according to the present invention;

FIG. 5 shows the side rail bracket of FIG. 4 positioned on a load platform;

FIG. 6 shows the side rail bracket of FIG. 4 positioned on a load platform, with a first end of the bracket attached to a side rail and a second end attached to a tie-down strap;

FIG. 7 shows a clearance between the side rail bracket, as positioned in FIG. 6, and a barrier element of a gate unit attached to the load platform;

FIG. 8 shows an exemplary schematic of the side rail bracket in FIG. 4; and

FIG. 9 shows an exemplary schematic of production measurements of the side rail bracket in FIG. 4.

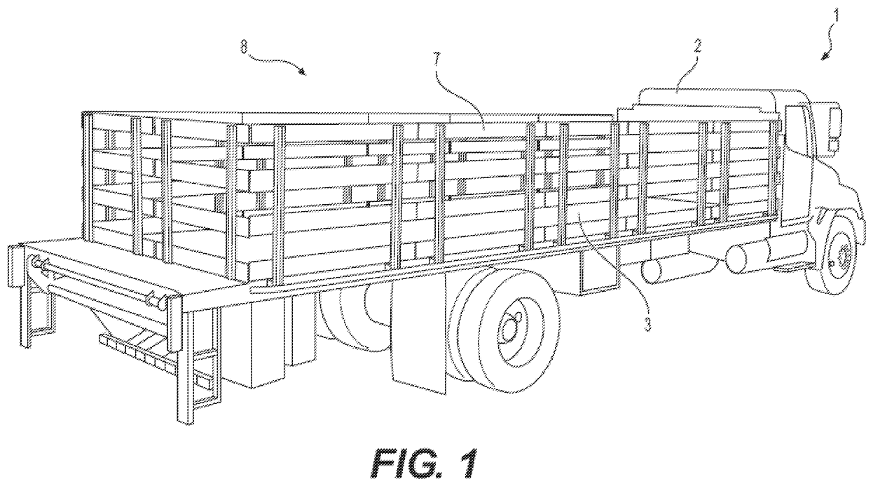

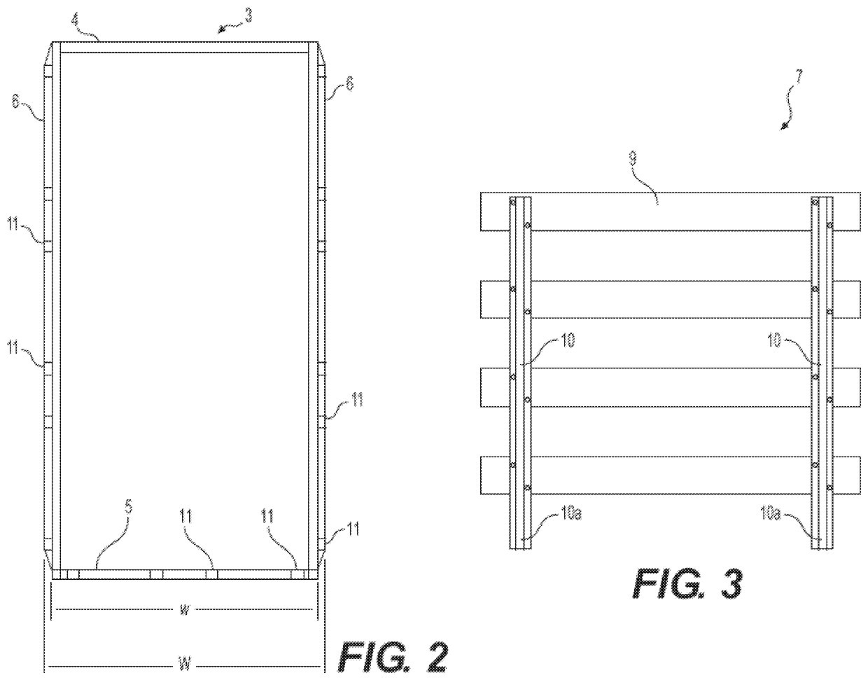

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of a bracket for use as an intermediate connector element for connecting a tie-down strap to a side rail of a load platform in a manner to avoid interference between the tie-down strap and a barrier element of a gate unit positioned at the perimeter of the load platform. The present invention is further inclusive of methods of using such brackets in securing loads on a load platform.

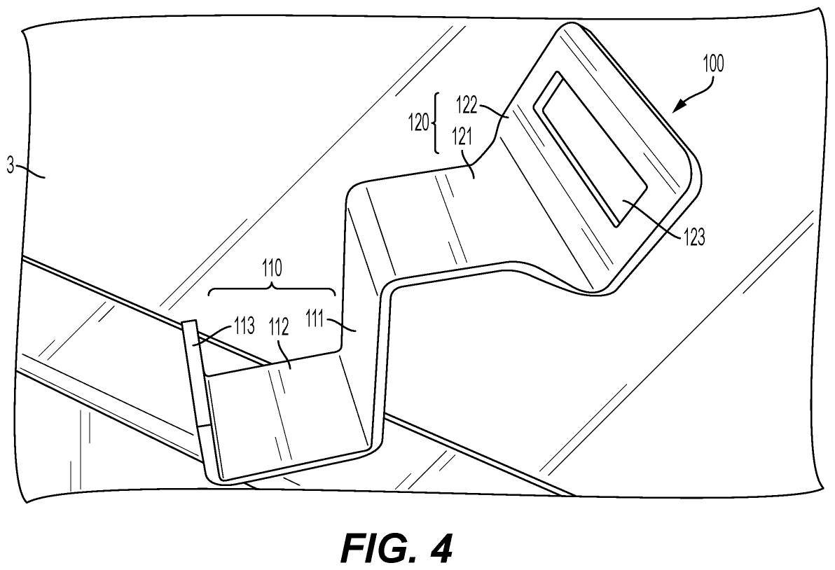

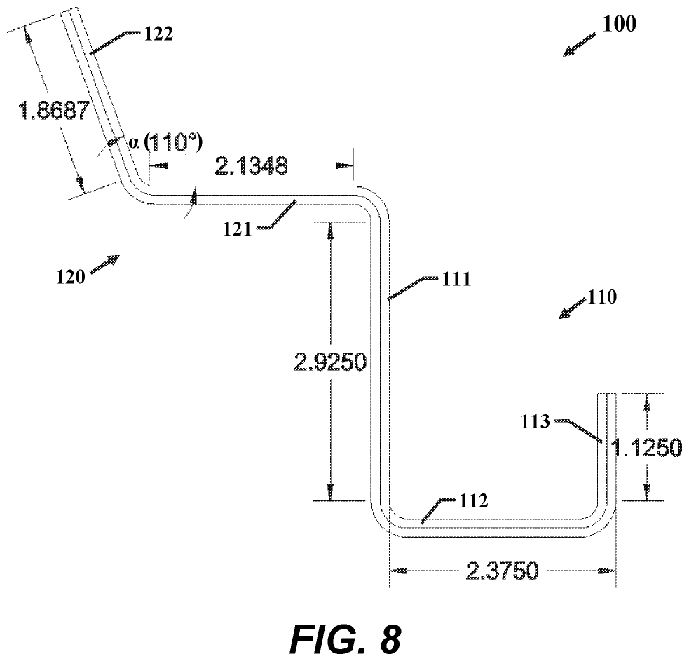

FIGS. 4-7 show one example of a bracket 100 according to the present invention. The bracket may be referred to as a connector bracket, a tie-down bracket, or a side rail bracket, and is generally an intermediate connector element for attaching a tie-down strap to a side rail 6. FIG. 8 shows a schematic of one example of a bracket 100 according to the present invention.

In this example, the bracket 100 is formed with a monolithic, single piece construction with several bends to form a body that is shaped to confirm to the side of a load platform 3. The bracket 100 has a first, side rail end 110 adapted for connecting to a side rail 6 and a second, tie-down end 120 adapted for connecting to a tie-down strap.

The side rail end 110 comprises a section 111 oriented vertically for extending downward along an outer side surface of a load platform 3, a section 112 oriented horizontally for extending away from the outer side surface of the load platform 3, and a section 113 oriented vertically for extending upward along an outer surface of a side rail 6. The section 111 and section 112 are joined by a 90° bend, and the section 112 and section 113 are also joined by a 90° bend.

The tie-down end 120 is made with a section 121 oriented horizontally for extending along an upper surface of the load platform 3, and a section 122 oriented at an obtuse angle α relative to section 121 for extending away from the upper surface of the load platform 3. Section 121 is joined to section 111 (at an end opposite section 112) by a 90° bend such that the sections 111 and 121 together conform to a corner of the load platform 3. Section 122 is joined to section 121 by an obtuse angle α such that section 122 extends away from the upper surface of the load platform 3 at a non-normal angle (i.e., a non-right, #90°, angle).

The obtuse angle α is in a range of 90°<α<180°, and is shown in FIG. 8 as α=110°. The bracket 100 may be made with a variety of angles α depending on the loads that are to be secured by the bracket 100. For example, brackets 100 intended for securing larger loads may be made with an angle α in a range of 90°<α≤1200; brackets 100 intended for securing medium size loads may be made with an angle α in a range of 120°<α≤150°; and brackets 100 intended for securing smaller loads may be made with an angle α in a range of 150°≤α<180°.

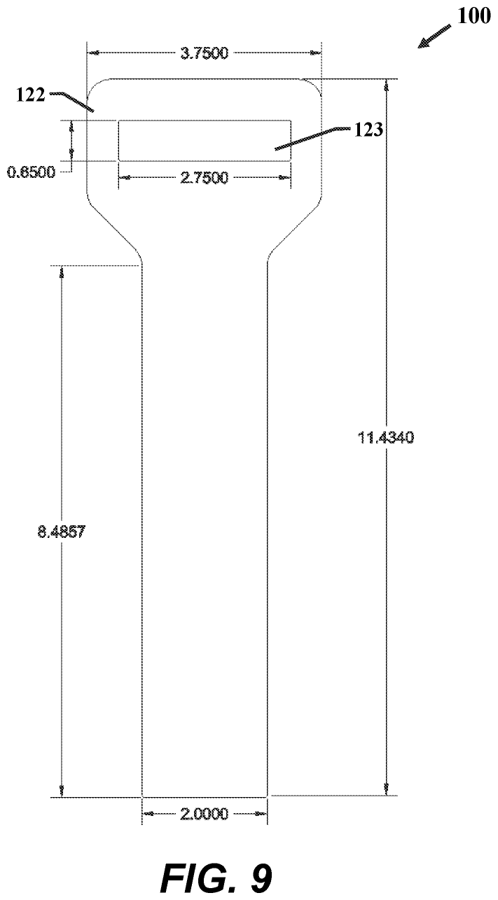

FIG. 9 shows a schematic of the bracket 100 body, prior to bending for formation of the several sections 111, 112, 113, 121, 122. As seen in FIG. 9, the sections of the bracket body forming the side rail end 110 (e.g., sections 111, 112, 113) may be made with a first constant width W₁, whereas the tie-down end 120 may be made with multiple widths (W₁/W₂). In the example shown in FIG. 9, section 122 is made with a second width W₂ that is greater than the first width W₁, and section 121 is made with a first portion having the first width a first width W₁ and a second portion that tapers in width from the first width W₁ to the second width W₂.

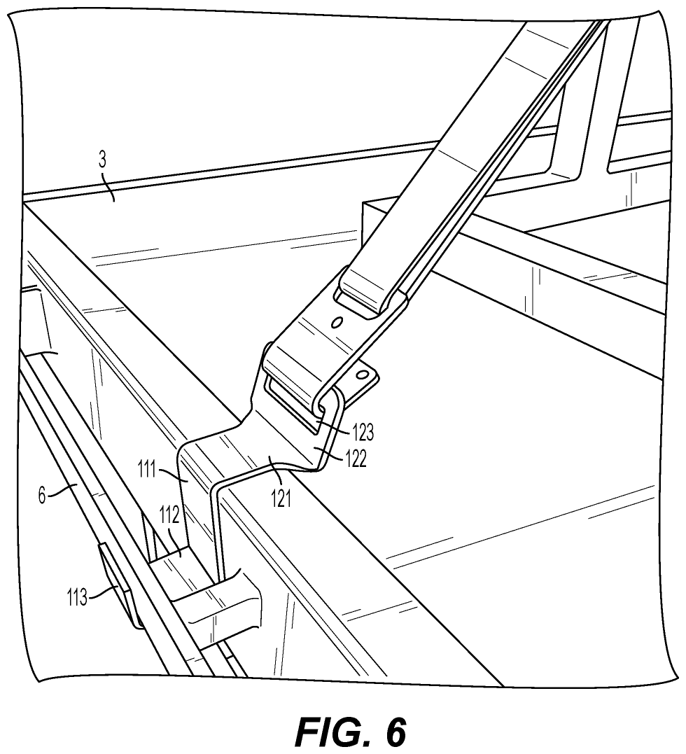

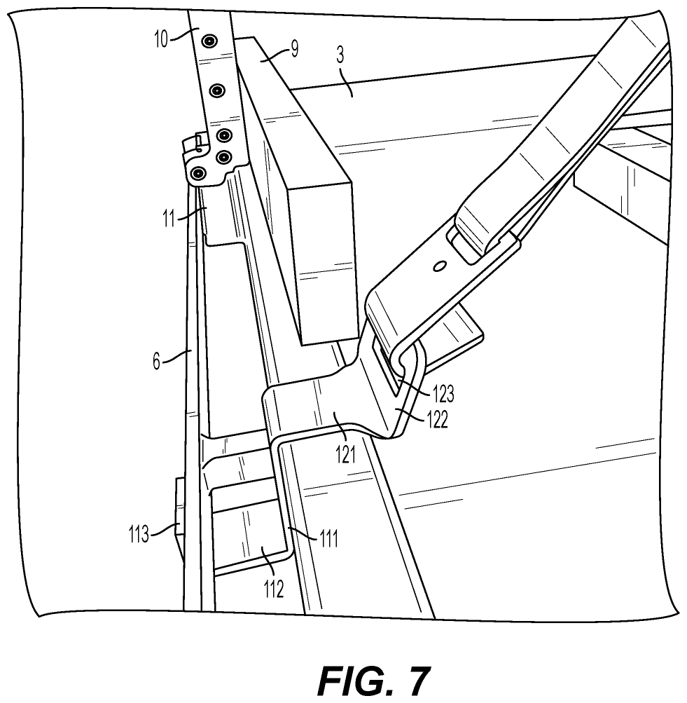

The tie-down end 120 is provided with a receptacle element 123 adapted for engaging with a fastener element of a tie-down strap. In the illustrated example, the receptacle element 123 is provided as a pass-through channel 123 for reception of a fastener element in the form of a hook, as illustrated in FIGS. 6-7.

In use, a user may place one or more brackets 100 in position on a load platform 3 prior to securing a load with one or more tide-down straps. Depending on the type of gate units 7 intended for use in transporting the load, if any, a user may find it convenient to position the bracket 100 prior to attaching one or more gate units 7 to the load platform 3. When using gate units 7 that are selectively repositionable relative to the load platform 3, while remaining attached to the load platform 3, such as those in U.S. Ser. No. 17/828,466 (Anderson), a user may find it convenient to place one or more brackets 100 in position on the load platform 3 while one or more gate units 7 are in a position that facilitates access to the load platform 3.

When placing a bracket 100 in position on a load platform 3, a user may insert sections 113 and 112 of the side rail end 110 between an outer side surface of the load platform 3 and an inner side surface of the side rail 6, and may then rotate the bracket 100 to a position in which section 121 rests against a top surface of the load platform 3, section 111 rests against an outer side surface of the load platform 3, and section 113 contacts an outer side surface of the side rail 6. When so positioned, section 122 will extend away from the top surface of the load platform 3.

After positioning the bracket 100 on the load platform 3, the user may then connect tie-down strap to the bracket 100 by engaging a faster element of the tie-down strap to the receptacle element 123 of the bracket 100. In the example shown in FIGS. 6-7, a tie-down strap is connected to a bracket 100 by engaging a hook fastener element to a pass-through channel 123 on the bracket 100. Once a bracket 100 has been positioned on the load platform 3 and connected to a tie-down strap, the gate units 7 may then be attached to the load platform, or otherwise rotated to a barrier forming position.

It will be understood that the foregoing method of use is exemplary only, and that a bracket 100 may be used in a number of other ways. For example, a user may first secure a bracket 100 to a fastener element of a tie-down strap, before positioning the bracket 100 on the load platform 3. Depending on the type of gate unit 7, it is possible that a user may position the bracket 100 on the platform 3 while the gate unit 7 is in a barrier forming position.

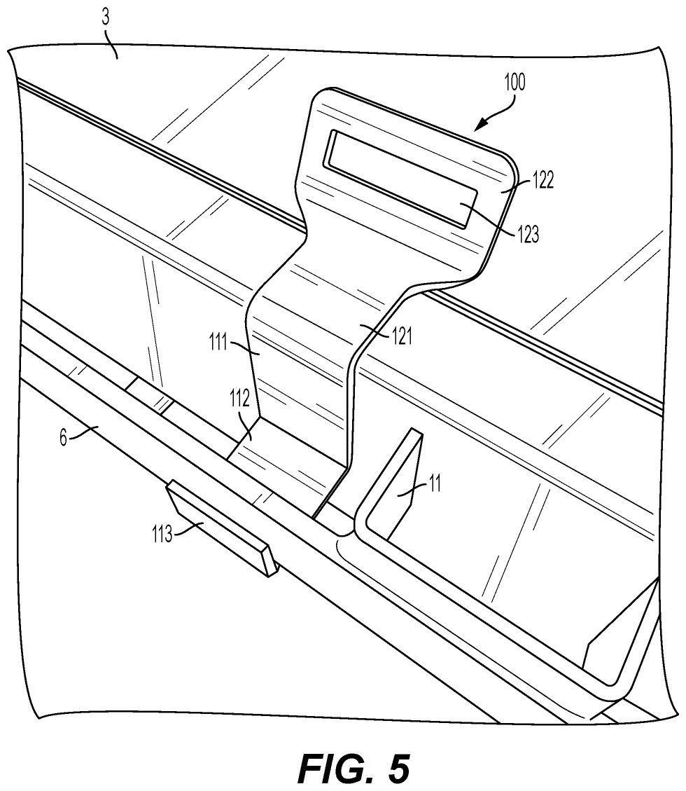

As shown in FIGS. 5-6, the bracket 100 is shaped and dimensioned to closely conform to the outer surfaces of the load platform 3. In particular, the bracket 100 is shaped and dimensioned such that, in use, section 111 may rest firmly against an outer side surface of the load platform 3 while the section 121 rests firmly against a top surface of the load platform 3. The section 121 is dimensioned to extend a sufficient length to reach from an outer edge of the load platform 3 to an inner load bearing region of the load platform 3. As shown in FIG. 7, the bracket 100 is adequately shaped and dimensioned such that the side rail end 110 may firmly engage a side rail 6 while the tic-down end 120 is accessible above the load bearing region of the load platform 3 all while avoiding interference with a barrier element (e.g., a slat 9) of a gate unit 7 that provides only minimal clearance from the top surface of the load platform 3.

Referring to FIG. 7, it is noted that under conventional practice a user would normally attempt to secure a tie-down strap by attaching the fastener element thereof directly to the side rail 6. However, the gate unit 7 in this illustrated example would preclude such a conventional use of the tie-down strap as the slat 9 would obstruct passage of the strap element of the tie-down strap in extending from the fastener element at side rail 6 and into the load bearing region of the load platform 3. Thus, the user would either have to identify an alternative structure on the load platform for use as an anchoring point for the tie-down strap, or otherwise forgo use of the tie-down strap.

The bracket 100 remedies problem presented with the conventional practice in the scenario shown in FIG. 7 by serving as an intermediate connector between the side rail 6 and a tic-down strap. Owing to the closely conforming construction, the bracket body (e.g., section 121) is capable of passing through the minimal clearance space provided between the slat 9 of the gate unit 7 and the top surface of the load platform 3 such that the side rail end 110 of the bracket 100 may be attached to the side rail 6 while the tic-down end 122 is accessible above the load platform 3 without interference from the slat 9 of the gate unit 7. In this way, the bracket 100 readily facilitates attachment of a tic-down strap to a preferred anchoring point (e.g., a side rail 6) in a scenario where a user would otherwise resort to a less preferred anchoring point or potentially forgo use of a tic-down strap.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated. No license, express or implied, is granted to any patent incorporated herein.

The present invention is not limited to the exemplary embodiments illustrated herein, but is instead characterized by the appended claims, which in no way limit the scope of the disclosure.

1. A bracket for use in securing a load on a load platform comprises:
a bracket body of monolithic, single piece construction having a first end and a second end, the first-end of the bracket body being adapted for connecting to a side rail of a load platform, and the second end being adapted for connecting to a tie-down strap,
wherein the bracket body is shaped and dimensioned to closely conform to outer surfaces of the load platform.

2. The bracket according to claim 1, wherein
the side rail end comprises a section oriented vertically for extending downward along an outer side surface of a load platform, a section oriented horizontally for extending away from the outer side surface of the load platform, and a section oriented vertically for extending upward along an outer surface of a side rail.

3. The bracket according to claim 1, wherein
the tie-down end comprises a section oriented horizontally for extending along an upper surface of the load platform, and a section oriented at an obtuse angle α relative to the horizontally oriented section for extending away from the upper surface of the load platform.

4. The bracket according to claim 1, wherein
the obtuse angle α is a range of 90°<α<180°.

5. The bracket according to claim 1, wherein
the obtuse angle α is a range of 90°<α≤120°.

6. The bracket according to claim 1, wherein
the obtuse angle α is a range of 120°≤α≤150°.

7. The bracket according to claim 1, wherein
the obtuse angle α is a range of 150°≤α<180°.

8. A method of using the bracket according to claim 1, comprising:
positioning the bracket on a load platform with the first end of the bracket body resting against a side rail of the load platform and the second end of the bracket body resting on a load bearing region of the load platform with a section of the second end projecting upward and away from the load platform.

9. The method according to claim 8, further comprising:
attaching a tie-down strap to the second end of the bracket body.

10. The method according to claim 9, further comprising:
securing a load in place on the load platform with the tie-down strap attached to the bracket.

11. The method according to claim 10, further comprising:
positioning a gate unit along a perimeter of the load platform such that the bracket is positioned to extend below a lowest barrier element of the gate unit.
